(19) United States
(12) Patent Application Publication
(10) Pub. No.: US 2007/0022034 A1
(43) Pub. Date: Jan. 25, 2007

(54) Systems and methods for a market economic approach for bonding a specific economic process for quality of life enhancements to elders

(76) Inventor: William R. Lenhard, Baltimore, MD (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/490,915

(22) Filed: Jul. 21, 2006

Related U.S. Application Data
(60) Provisional application No. 60/701,090, filed on Jul. 21, 2005.

(51) Int. Cl. G06Q 40/00

(52) U.S. Cl. 705/35

(57) ABSTRACT

A method for bonding of a specific economic process for provision of quality of life enhancements to elders is described. At least one financial contribution from a financial contributor is received by a funding entity. The at least one financial contribution is used to contribute to a targeted investment program. As a result of the investment, revenue generated may be provided to the funding entity for the benefit of and to improve the quality of life for a grantor during the life of the grantor. Assets of the targeted investment program may be distributed to at least one the financial contributor and the funding entity upon the death of the grantor.

### FIELD OF THE INVENTION

This application relates to systems and method for providing elder care and, more particularly, relates to systems, methods and financial instruments that provide an economic process for selective quality of life enhancements for elders and financial incentives to participating financial contributors.

### BACKGROUND OF THE INVENTION

With increasing life expectancies and the resulting aging population, there are a plethora of problems that arise when caring for the aged in today's contemporary society. These types of problems usually involve how to provide services (medical, food, counseling, therapy, housing, etc.) to elders while dealing with the costs of such services. Addressing these problems often places aging people (also generally referred to as “elders” or “grantors” in the context of this disclosure) in financial difficulty, as the desired services can become overwhelmingly expensive. Indeed, the burden of caring for an aging person itself can be mentally and physically overwhelming as well.

Therefore, what is needed is an integrated, comprehensive process designed to solve the problems of financing, caring, and providing life enhancements for an aging person in contemporary society.

### SUMMARY OF THE INVENTION

In accordance with the invention, systems, methods, and financial instruments for bonding a specific economic process for quality of life enhancements to aging persons or elders is described. In one aspect of the invention, a method is described that begins when a contribution is made by a financial contributor to a funding entity or foundation. The financial contributor may be a donor, such as an individual, but not necessarily related to a grantor or elder. Alternatively, the financial contributor may be a lender, investor, or any other suitable source of funding. The funding entity then uses the contribution or the paper value of a portfolio of contributions to invest in a targeted investment program, such as a high yield trading platform, to generate revenue. The resulting revenues from the investment program are provided to the funding entity in order to help improve the quality of life for a grantor or elder during the life of the grantor. Upon the death of the grantor, the assets of the targeted investment program are distributed to the financial contributor and/or the funding entity.

In another aspect of the invention, a financial instrument is described that provides quality of life enhancement benefits to aging persons. The financial instrument comprises a life insurance policy on a grantor for purchase by a funding entity with funds contributed by a financial contributor. In one suitable arrangement, the portion of the revenues provided by the financial contributor is used for two purposes: (1) pay premiums on the life insurance portfolio, and (2) improve the quality of life for the grantor during the life of the grantor. In another or additional arrangement, a financial value may be calculated or hypothecated on the life insurance portfolio, for example, by a financial institution that engages in the trading of such hypothecated values. The funding entity may subsequently use the hypothecated value on the portfolio to secure cash loans for making investments, for example, in the above-mentioned targeted investment program to generate additional revenues, which may be used to provide services to the grantor. Upon the death of the grantor, the assets of the life insurance policy are distributed to the financial contributor and/or the funding entity, for example, based on a sliding scale.

A variety of other aspects of the invention are described in more detail below. Further, it is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is an exemplary block diagram illustrating the primary transactions and interactions among various entities in accordance with an embodiment of the present invention.

FIG. 2 is an exemplary sliding scale distribution scenario for distributing benefits of a life insurance policy between the funding entity and a financial contributor in accordance an embodiment of the present invention.

FIG. 3 is a flow chart of illustrative stages involved in bonding a specific economic process for quality of life enhancements to elders in accordance with an embodiment of the present invention.

### DESCRIPTION OF THE EMBODIMENTS

Reference will now be made in detail to exemplary embodiments of the inventions. Basically, a comprehensive process to provide life enhancements for an aging person in contemporary society may cover both the funding of the solution as well as selecting and providing programmatic services of the solution to these eldercare problems. As a context for an embodiment of the invention, it is important to understand the concept of humanitarian innovation in a market economy. Programmatic change is intrinsically a function of economic process. Quality of life enhancement is the goal. All change is directly contingent on the motivation of private sector financial entities enabling the promise of a private foundation to deliver quality of life enhancement benefits to people 70 and older. Thus, an embodiment of the invention generally involves a method of bonding a unique and specific economic process with specific programmatic solutions that cause quality of life enhancements to elders in a way that no other method can replicate.

In the example described below, a financial contributor may be a donor, such as an individual. Alternatively, the financial contributor may be a lender or investor, such as a bank, a financier, a mutual or hedge fund, or any other suitable source of funding. The grantor (a.k.a. an aging person or an elder) is an older man or woman selected to participate in an ongoing life care program (the selection process is further described below). The financial contributor and grantor need not be related. The example also describes a funding entity or foundation, specifically referred to as the Elder LifeCare Foundation Trust that uses targeted investment programs (e.g., life insurance policies, etc.) in innovative ways.

In general, grantors are told about the programs offered by the funding entity to help them with their quality of life. A group of grantors are selected to participate in the programs. Each selected grantor chooses which programs are desired. For example, nursing or depression counseling may be desired for a particular grantor. These programs have associated costs, but the cost would not be passed on to the grantor, but instead would be paid by the funding entity (the Foundation). The grantor grants the funding entity the right to obtain life insurance on the grantor's life. The funding entity then applies for life insurance on the grantor. In support of this effort, the funding entity (the Foundation) arranges for a financial contributor to provide the premium for the life insurance policy and helps to underwrite the services and programs that are provided to the grantor/elder.

A more detailed description of the funding aspect and programmatic solutions aspect of an embodiment of the present invention are provided below.

Economic Process (Proprietary Funding)

1. Humanitarian Innovation in the Market Economy

Working closely with financial advisors in the life insurance industry, the funding entity has evolved a market economy method to fund humanitarian innovations. The developed process calls on the power of the financial marketplace to fund critically needed programs for elders and to realize a significant return in a way that encourages a sustainable interest from financial contributors, who are asked to fund the funding entity's insurable interest promises in the form of present program benefits that directly enhance and sustain quality of life for its elder members.

2. Insurable Interest

The insurable interest of this novel program is support by two major reasons:
(1) The agenda of the funding entity is structured to serve life-enhancing interests critical only to the needs of people over a threshold age, such as 70 years of age. Besides a program that monitors and advises elders on life-enhancement strategies that focuses on health, safety, security, and longevity of the individual, one easily could say that all of the funding entity's programs constitute a direct and significant value contribution to the life and well-being of each elder person. Sustaining such programs is understood by all to be of high interest to all elder persons. Conversely, any threat to such programs could adversely affect the safety, security, maintenance, longevity, health and quality of life of elders who are able to capture the services of such programs. As a service for elders, the funding entity meets conventionally known tests of an insurable interest.
(2) In one embodiment of the present invention, the primary insurable interest served by this program is consistent with and virtually at the core of current life insurance industry practice, which is to protect the funding entity against potential financial risks associated with, for example, paying direct costs of housing and healthcare services out of its endowment. Under cost recovery rationale, the mortality benefits on life insurance policies issued against grantors enrolled in the funding entity's program are reasonable for recovering the costs paid by the funding entity to provide for enhancement services to these grantors. Moreover, life insurance assets enable the funding entity to provide present day benefits to grantors by leveraging a certain future financial event that promises to restore present costs associated with the provision of services and enables the benefits to be sustainable and scalable. From the funding entity's perspective, the life insurance policy mitigates the financial risks associated with the costs of providing quality of life enhancements to its elder members. The cost recovery objective of using life insurance will allow the funding entity to continue providing benefit services to the exponentially expanding needs of the retirement explosion currently in progress.
   3. Ownership

In an exemplary embodiment, the Elder LifeCare Foundation and/or its financial guardian, ELF Trust Company, is the sole owner and applicant of the life insurance policy issued on the life of the insured, in this case a grantor, who authorizes the foundation to apply for and own a life insurance policy on his or her life by “granting permission”. In an alternative arrangement, the ownership of the life insurance policy may be held by a financial contributor to the ELF Trust Company or may be held collectively by both a financial contributor and the ELF Trust Company.

4. The Process—A Better Way

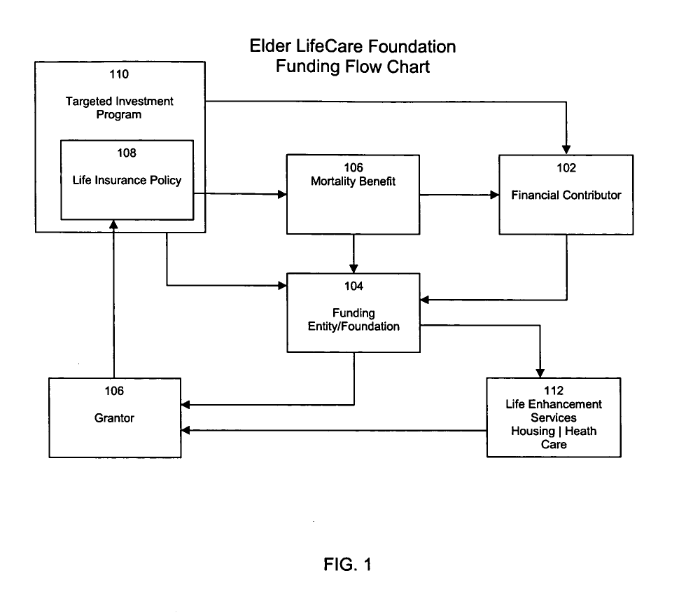

To improve efficiency, dramatically increase yields, guarantee insurable interest and enhance the ethics of the process, there need be only three entities in the transaction, (1) the grantor or elder, (2) the funding entity or foundation, and (3) the financial contributor of the funds. Accomplishing these improvements involves operationalizing a few simple concepts among these entities. FIG. 1 shows an exemplary diagram of the primary transactions and interactions among the above entities.

Referring now to FIG. 1, a financial contributor 102, who may be a donor, a lender, an investor, or any other source of funding makes one or more financial contributions to funding entity/foundation 104. The one or more financial contributions may come in a variety of forms, such as a single lump sum payment or numerous periodical payments.

A grantor 106 or elder involved with funding entity 104 grants funding entity 104 the right to use their involvement for the benefit of funding entity 104. Specifically, grantor 106 gives permission to funding entity 104 to apply and own a life insurance policy 108 in the name of grantor 106. To secure life insurance policy 108, funding entity 104 utilizes the funding provided by financial contributor 102 to pay the necessary premium or other associated cost. In some suitable arrangements, the ownership of life insurance policy 108 may be held by financial contributor 102 or shared jointly by both funding entity 104 and financial contributor 102.

Alternatively or additionally, funding entity 104 may invest the lump sum or periodical contributions made by financial contributor 102 in another specific, targeted investment program 110. Both life insurance policy 108 and targeted investment program 110 will generate revenue to fund the endowment trust of funding entity 104, which is then used to provide life enhancement services to grantor 106.

In the case of targeted investment program 110, the generation of revenue may be similar to commonly known investment programs. In the particular case of life insurance policy 108, two types of revenue generation operations may be involved. First, the face value of life insurance policy 108 may be evaluated to hypothecate a tradable value, which may be utilized to secure cash loans for investing, for example, in another targeted investment program 110, thereby generating a stream of revenue. Second, when grantor 106 dies, the mortality benefit 110 associated with life insurance policy 108 may be apportioned to both funding entity 104 and financial contributor 102, for example, according to a sliding scale. Examples and further details of such a sliding scale will be discussed in more detail below.

Using the endowment that is enhanced by the various sources of revenues discussed above, funding entity 104 is able to provides individualized services 112 designed to improve the quality of life of grantor 106. The targeted services will improve the safety, security, health, and longevity of grantor 106; thereby, improving his/her quality of live. This tripartite relationship is maintained during the lifetime of the grantor.

Upon the death of grantor 106, all assets in that grantor's associated account of targeted investment program are shared with financial contributor 102 and that account is closed, since it no longer is required to provide quality of life services to that particular grantor. As mentioned above, in one suitable arrangement, funding entity 104 and financial contributor 102 may collaboratively, but not necessarily equally share as beneficiaries of the investments made by funding entity 104. One exemplary sharing method is a sliding scale method for determining the distribution of the relative assets of the investment program. Generally speaking, a sliding scale adjusts how assets are distributed from an initial distribution to an alternative distribution over time. The sliding scale method ensures fairness to funding entity 104 while also guarantees sustained financial interest of financial contributor 102 that meets the requirements of insurable interest. For example, the assets may be apportioned so that the longer grantor 106 lives the greater the distribution share to financial contributor 102. The arrangement is fair in view of the greater amount of contribution that financial contributor 102 had to make during the relevant living years of grantor 106.

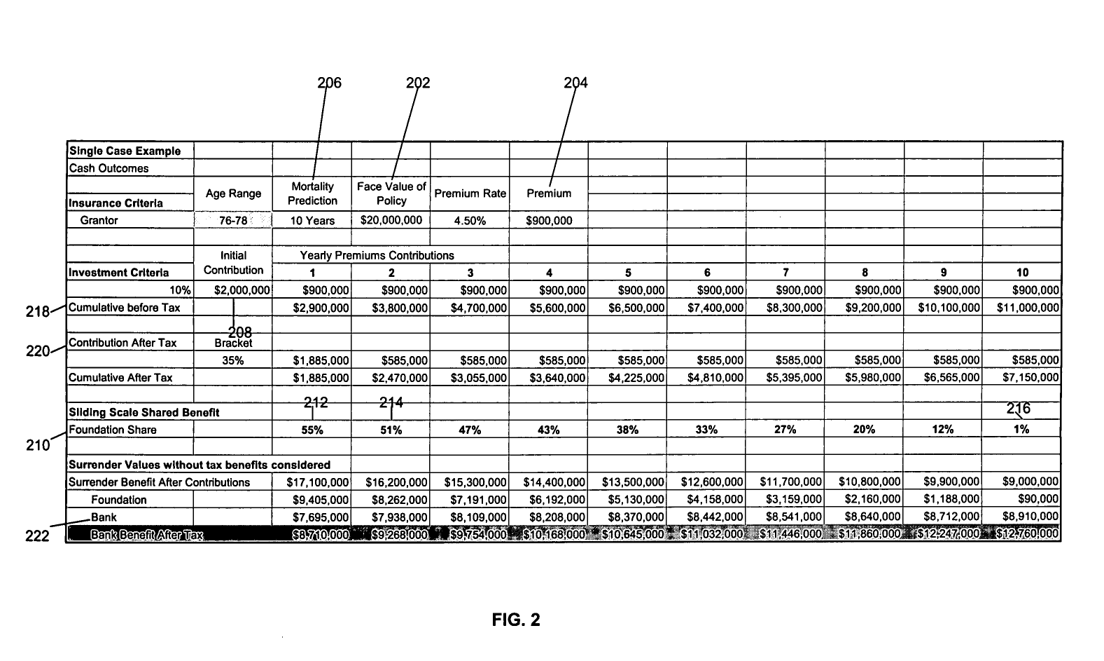

One example of a sliding scale consistent with an embodiment of the present invention is shown in FIG. 2. In this particular example, a grantor has given permission for the funding entity to secure a life insurance policy having a face value (202) of $20,000,000 that requires premium contribution (204) of $900,000 on a yearly basis. Based on the grantor's current age, a mortality prediction (206) of 10 years is made. An initial contribution (208) of $2,000,000 is also required on the policy.

In consideration of the large initial contribution and the periodical yearly contribution thereafter by the financial contributor, a sliding scale (210) for sharing the benefits of the policy is devised such that the share received by the funding entity/foundation is reduced each year for the 10 year period. Specifically, if death of the grantor results in year 1, the funding entity/foundation will receive 55% (212) of the policy benefits, while the financial contributor will receive the remaining 45%. If death results in year 2, the funding entity/foundation's share reduces to 51% (214) with the remaining 49% going to the financial contributor. The funding entity/foundation's share reduces even further for the next 8 years until it eventually reaches 1% (216) in year 10.

The reductions in share of the funding entity/foundation is justified in view of the increased contribution made by the financial contributor through the years. Rows 218 and 220 illustrate the specific cumulative contributions made by the financial contributor in each of the years both before and after tax. Through the use of the sliding scale, the funding entity/foundation is able to ensure that a substantially similar benefit (shown in row 222) is provided to the financial contributor regardless of when death results. In this way, the sliding scale ensures a sustainable incentive for the financial contributor to make contributions throughout the life of the grantor.

Those skilled in the art will understand that FIG. 2 is merely given as an example of a suitable sliding scale method of distribution. Any other suitable scales may be used without departing from the spirit of the present invention.

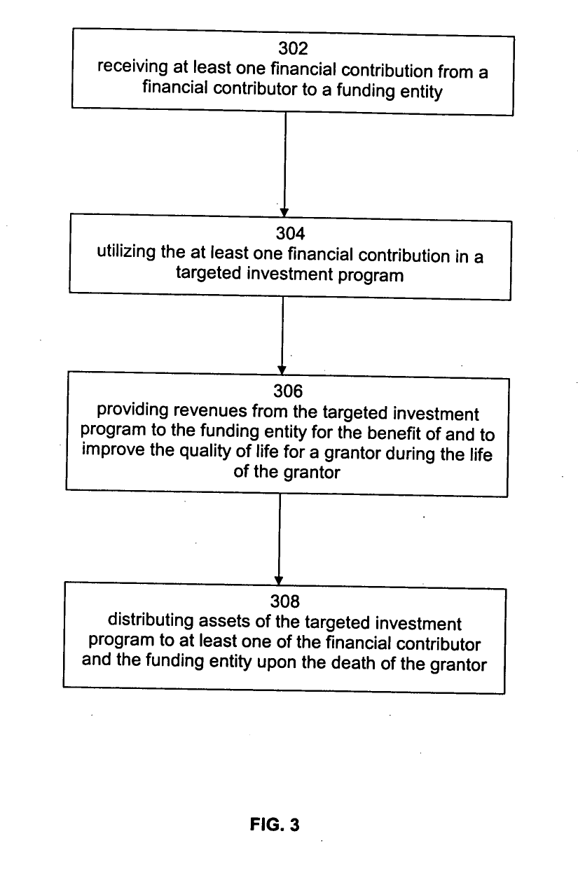

In summary and at a high level, an embodiment of the bonding of a specific economic process for provision of quality of life enhancements to elders involves a series of stages, which are illustrated in the exemplary flowchart of FIG. 3. Referring now to FIG. 3 at stage 302, at least one financial contribution from a financial contributor is received by a funding entity. As mentioned above, the contribution may be one lump sum payment or numerous periodical payments. At step 304, the at least one financial contribution is used to contribute to a targeted investment program, where the targeted investment program may be, for example, a known investment program or a life insurance policy on the life of the grantor. As a result of the investment in the targeted investment program, revenue generated may be provided to the funding entity for the benefit of and to improve the quality of life for a grantor during the life of the grantor at stage 306. Finally, assets of the targeted investment program may be distributed to at least one of the financial contributor and the funding entity upon the death of the grantor at stage 308.

As for how the grantors can be chosen, a group of grantors are typically selected from the population for participation in the programs that improve their quality of life in an embodiment of the invention. A selection process is typically used to help keep the group of grantors collectively matching the standard mortality tables. For example, using a statistical process that employs a stratified-random sampling strategy, grantors can be selected in groups drawn from the population described by mortality tables in a way that the sample group is expected to perform like the population from which it was drawn. In one example, 80 elders may be initially identified as interested in the programs, but only a subset of these elders is eventually selected. To find the right subset, iterative analysis may be done to look for a “goodness of the fit” for the current subset of elders. Based on the closeness of the fit between the subset and the mortality tables, some elders in the subset may be dropped out and others added in to make a new subset. This new subset is analyzed to determine the “goodness of the fit” as well until these subsets show strata and the best fit can be selected. This type of selection process is designed to provide controls for reliability and validity, both with regard to the power of prediction and the lack of variable assumptions common to the rationale underlying life expectancy prediction models. Over time, and as the population of elders served increases, the underwriting risk is consistently and unilaterally reduced thereby continuously relaxing the sample selection criteria to the point that virtually allows increasingly broader acceptance of elders into the program.

Under this model, the confidence levels in predicting financial performance are best controlled by aggregate processing. Therefore, it is desired that all grantor life insurance applications that comprise the sample would be submitted for processing together in the same time frame.

Win-Win Outcomes

1. Financial contributor gains significant incentives, substantial tax-qualified contributions while sharing in benefits on policy surrenders.
2. Insurance companies enjoys steady stream of high premium customers with immediate and long-range annuity and financial planning services needs.
3. The Funding Entity/Foundation builds the capital necessary to deliver compelling promise of life enhancing insurable interest benefits to senior citizens.
4. Grantors/Elders gain meaningful quality of life benefits.

The incentives for the financial contributor may come in a variety of forms. For example, there is an incentive for the financial contributor based upon public awareness. Essentially, participation in this program is a type of public relations benefit to the financial contributor for playing a significant role in providing quality of life enhancements for elders. A financial incentive also exists with regard to a return on the financial contributor's initial and/or premium contributions. This incentive would materialize in the form of the death benefit payout being larger than the contributions made. Yet another exemplary benefit for the financial contributor is a tax-based financial incentive. For example, the U.S. tax code may provide for special tax advantaged treatment for the financial contributor as a direct or indirect result of the financial contributor's contribution in a socially-beneficial program.

In an alternative embodiment, a modified approach to funding may be used. In this alternative approach, an insurance carrier services in the role of writing the policy as well as funding the premiums and making contributions (or loans) to the funding entity/foundation. As such, the insurance company (or other type of financial entity) serves as both the life insurance underwriter and the financial contributor. In such an embodiment, there is no need for an independent source for the financial contributions.

Programmatic Solutions (Quality of Life Benefit Programs)

In one embodiment, to resolve funding issues to solve the problems of the aging person, The Elder LifeCare Foundation Trust uses life insurance policies in an innovative fashion. Each person with whom the Elder LifeCare Foundation works has an opportunity to decide which of the complex of programs he/she chooses to become involved in a key fashion. By matching the individual's choices with the panoply of programmatic opportunities, an individualized LifeCare plan is developed for that particular elder citizen in his/her path to an improved quality of life. This person then grants the foundation the right to insure his/her life for the costs of supporting his/her involvement in this individualized LifeCare plan.

In an embodiment of the invention, to resolve many of the safety, security, health and longevity issues of the aging person, The Elder LifeCare Foundation Trust has developed the Elder CareCheck Program to cater to the various needs of the elder persons. In one example, a program of this type may include combinations of the following services:

Level I

Suicide Probability Assessment

Anxiety Assessment

Clinical Depression Assessment

Weekly Nursing/Case Management Calls

Internet Connection

Access to the Web Page

The Foundation Newsletter

Level II

Monthly Face-to-Face Nursing/Case Management Visits

Monthly Check of Vital Signs

Monthly Check of Medications

Monthly Check of Food and General Conditions

Level III

Emergency Phone Number

Six Medical Consultation Phone Visits per Year

Level IV

Twelve Medical/Psychiatric Seminars

ELF Med-Oversight Program Coverage

ELF Med-Oversight Medical Records Storage

Medical Records Downloading

ELF Med-Oversight Program Equipment and Enrollment

ELF Laptop and Camera for ELF Medical Seminars

In one suitable arrangement, the Elder LifeCare Foundation Trust may provide an ElderCare Housing and Urban Development Program in accordance with an embodiment of the invention in order to resolve the housing problems of aging persons. In this program, the Trust may acquire property (e.g., ten to twenty acres of land), prepare the land, and build residential housing on the land (e.g., thirty freestanding, furnished 2,000 square feet houses). These houses may be available at no cost to the aging person couples selected for this program. On this well designed and landscaped plot of land, there may be housing for many of the other programs of services designed by the Trust.

In order to resolve the problems associated with inadequate Social Security funding for the aging persons, the Foundation may work jointly with the couples selected for this program and one of the financial institutions with whom the Elder LifeCare Foundation has developed working relationships and work out developing an immediate pay annuity for the older couple.

In order to resolve the Long-Term Care issues of the aging person, the Trust may provide a comprehensive program of support services offered to couples participating in the ElderCare Housing and Urban Development Program in an embodiment of the invention. In this complex of services, comprehensive support services may be offered to help the elder achieve an elevated quality of life through modifying the environment and providing support services sufficiently to allow him/her to live in his/her residence as long as possible and ideally until his/her death. These support services may include all required nursing care; a local, dietician planned meal service delivered through congregate dining up to the delivery of individual meals to the person in his/her home; an outpatient partial hospitalization-like psychiatric support services to ameliorate the disabling symptoms of clinical depression, elevated probability of suicidal behavior, and generalized anxiety.

In order to resolve the stresses created in aging persons by having dependent, adult “children” afflicted with disabling neurodevelopmental disorders and/or grandchildren with such disabling conditions, the Trust may provide a residential education and support program that provides for the care and support of the disabled person for the remainder of his/her life at no cost to the identified disabled person or the elderly family member. These programs may be located on the same plot of land as the ElderCare Housing and Urban Development Program or on land located near by, or perhaps in a remote site developed specifically for this program. This program may provide a wide range of prescriptive special education and individual and group cognitive behavioral psychotherapy along with all the routine support services required for a quality life style.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for bonding a specific economic process for quality of life enhancements to elders, comprising:
receiving at least one financial contribution from a financial contributor to a funding entity;
utilizing the at least one financial contribution in a targeted investment program;
providing revenues from the targeted investment program to the funding entity for the benefit of and to improve the quality of life for a grantor during the life of the grantor; and
distributing assets of the targeted investment program to at least one of the financial contributor and the funding entity upon the death of the grantor.

2. The method of claim 1, wherein the at least one financial contributions are periodical.

3. The method of claim 1, wherein the financial contributor is one of a donor, a lender, or an investor.

4. The method of claim 1, wherein the targeted investment program is a project funding trading platform.

5. The method of claim 1, wherein the amount of the at least one financial contribution and the revenues from the targeted investment program are individualized according to the perceived needs of the grantor.

6. The method of claim 1, wherein the funding entity utilizes the revenues from the targeted investment programs to provide benefits to the grantor through its endowment trust.

7. The method of claim 1, the utilizing step further comprises purchasing life insurance on the life of the grantor by the funding entity as the targeted investment program, the funding entity being the applicant, owner and irrevocable beneficiary of the life insurance

8. The method of claim 1 further comprising providing an incentive to the financial contributor.

9. The method of claim 8, wherein the incentive is a tax incentive for the financial contributor.

10. The method of claim 1 further comprising creating a pre-determined care plan for the grantor.

11. The method of claim 10, wherein the pre-determined care plan identifies individualized care services to be provided for the benefit of the grantor.

12. The method of claim 1, wherein the distributing step further comprises sharing the assets of the targeted investment program between the funding entity and the financial contributor, the funding entity receiving a first portion of the assets and the financial contributor receiving a remaining portion of the assets.

13. The method of claim 12, further comprising dividing the assets into the first portion and the remaining portion according to a flexible method when distributing the assets.

14. The method of claim 13, wherein the flexible method further comprises a sliding scale method that balances fairness to the funding entity and a sustained financial interest for the financial contributor over time.

15. The method of claim 12 further comprising utilizing the first portion of the revenues for a housing project that benefits the grantor.

16. The method of claim 15, wherein the housing project further comprises purchasing real estate and developing the real estate to provide at least one residence for use by the grantor.

17. The method of claim 15, wherein the housing project further comprises modifying a residence used by the grantor.

18. A financial instrument for providing quality of life enhancements to elders, comprising
a life insurance policy on a grantor for purchase by a funding entity with funds contributed by a financial contributor;
wherein the life insurance policy funds are invested to provide revenues on a sliding scale to both the funding entity and the financial contributor; the portion of the revenues provided to the funding entity being used to improve the quality of life for the grantor during the life of the grantor;
wherein the assets of the life insurance policy are distributed to the financial contributor upon the death of the grantor.
